(19) United States
(12) Patent Application Publication
(10) Pub. No.: US 2003/0016761 A1
(43) Pub. Date: Jan. 23, 2003

(54) Method and apparatus for controlling digital filter of a radio transmitter

(75) Inventor: Kyung-Ho Min, Suwon (KR)

Correspondence Address: JONATHAN Y. KANG, ESQ., LEE & HONG P.C., 11th Floor, 221 N. Figueroa Street, Los Angeles, CA, 90012-2601, US

(73) Assignee: LG Electronics Inc.

(21) Appl. No.: 10/199,794

(22) Filed: Jul. 19, 2002

(30) Foreign Application Priority Data
Jul. 21, 2001 (KR) 43978/2001

(51) Int. Cl. H04L 27/36

(52) U.S. Cl. 375/298

(57) ABSTRACT

A digital filter control method and apparatus is provided. One embodiment of the invention comprises: an analog/digital converter for converting an analog signal to a digital signal; a data processing unit for compressing and error-correcting the digital signal; a coder for coding the signal provided by the data processing unit to an I signal and a Q signal; a digital filter for wave-filtering the I and Q signals; a modulator for modulating the I and Q signals into an intermediate frequency (IF) signal; a mixer for up-converting the IF signal into a radio frequency; a bandpass filter (BPF) for filtering the up-converted radio signal; an amplifier for amplifying the filtered radio frequency signal; and a filter control means for controlling a roll-off factor of the digital filter.

### CROSS-REFERENCE TO RELATED APPLICATIONS

Pursuant to 35 U.S.C. §119(a), this application claims the benefit of earlier filing date and right of priority to the Korean Application No. 2001-43978, filed on Jul. 21, 2001, entitled “APPARATUS AND METHOD FOR CONTROLLING DIGITAL FILTER OF RADIO TRANSMITTER” the content of which is hereby incorporated by reference herein in its entirety.

### BACKGROUND OF THE INVENTION

1. Field of the Invention

The invention relates to a radio transmitter, and more particularly, to a method and apparatus for controlling a digital filter in a radio transmitter used in a wireless local loop (WLL) system.

2. Discussion of the Related Art

A filter is used in the transmitting part of a subscriber terminal of some communication systems to support transmission over specific frequencies. The degree of inclination of band limitation is called a roll-off factor (α) and the filter characteristic can be changed as the roll-off factor value changes in a range of zero to one (e.g., 0≦α≦1).

If the roll-off factor value is reduced, the filter properties are enhanced. A power amplifier having a high power gain is required to operate in a linear region due to a power peak increase. Meanwhile, if the value of the roll-off factor (α) of the filter is high, a power amplifier with a low power gain can be used. In such a case, however, the filter properties are degraded and filter efficiency is reduced. Research has been conducted for a circuit design that can maintain the roll-off factor of a filter in an optimal state while the power amplifier operates in a linear region.

FIG. 1 is a block diagram of a transmitting part of a subscriber terminal in accordance with conventional art. As shown in FIG. 1, when an analog signal is provided for transmission, an analog/digital converter 10 converts the analog signal to a digital signal. The converted digital signal is compressed and error-corrected in a data processing unit 20 and then coded in a coder 30. The coded signal is sent to a baseband digital filter 40 as In phase (I) and Quad phase (Q) output signals to be filtered. A modulator 50 modulates the output signals to produce an intermediate frequency (IF) signal. The IF signal is up-converted into a high frequency signal by a mixer 60, and is provided to a bandpass filter 70. The bandpass filter 70 filters the unnecessary noise signals out of the high frequency signal. Thereafter, the high frequency signal is amplified by an amplifier 80 and is transmitted via an antenna.

The filter properties of the baseband digital filter 40 depend on the value of the roll-off factor of filter 40. Typically, the lower the roll-off factor, the better the filter properties. However, in order to lower the value of the roll-off factor, that is, to better filter the signals, a high power peak is needed. To produce a high power peak, a power amplifier having a large power gain is required. Unfortunately, in such a case, the Error Vector Magnitude (EVM) increases in a signal point constellation of data.

FIGS. 2A and 2B are graph diagrams illustrating the filtering properties and impulse responses in a typical raised cosine filter. As shown in FIG. 2A, when the roll-off factor (α) is 0, the transfer characteristic curve h(t) is in the shape of a square wave in which a digital signal can be ideally filtered. As the roll-off factor increases, other frequency components pass through the filter. Referring to FIG. 2B, it is noted that the lower the roll-off factor, the fewer are the included harmonic components; while the higher the roll-off factor, the greater are the included harmonic components. If the roll-off factor is lowered in order to enhance the filtering performance of the digital filter 40, the required power peak increases such that it is required to magnify the linearity of the amplifier.

FIGS. 3A, 3B, and 3C are vector diagrams of Quadrature Phase Shift Keying (QPSK) signals where the roll-off factors of the digital filter are respectively 1.0, 0.75 and 0.375. If the filtering is not performed as shown in FIG. 3A (i.e., α=1.0), the frequency transfer is ideal so that no excessive response is needed, thus requiring little amplification power for the amplifier 80.

As shown in FIGS. 3B and 3C, however, if the roll-off factor (α) is lowered to 0.75 and 0.375, respectively, the transfer frequency slows down due to generation of excessive step response. Especially, when the roll-off factor is 0.375, an excessive amount of step response is generated requiring additional amplification. As shown, the output signal overshoots and results in an increase in the number of error vectors.

Generally, the reason for adjusting or limiting the roll-off factor of a filter is to set a passband in which the filter is intended to transmit signals. When the passband becomes narrower as the roll-off factor a is lowered, simultaneously the excessive response inevitably increases and causes errors in the vector locus.

For example, when the roll-off factor is 0.2, an additional power increase of about 5 dB is required, due to the overshoot of the signal vector locus. This can be a burden when designing the power amplifier 80. Also, the typical digital filter used in a WLL transmitter has a roll-off factor set in the range of 0.3 to 0.5 and requires high amplification power for amplifying the output signal from the filter in the linear region. This results in an increase in the size of the subscriber terminal as well as that of the amplifier, leading to an increase in manufacturing costs. Thus, a method and apparatus is needed to overcome the above-referenced shortcomings.

### SUMMARY OF THE INVENTION

The invention is directed to a method and apparatus for controlling a digital filter of a transmitter by adjusting the roll-off factor of the digital filter based on I phase and Q phase signals provided by the filter and a corresponding amplifier in said transmitter.

Additional advantages, objects, and features of the invention will be set forth in the description which follows and, in part, will become apparent to those having ordinary skill in the art upon examination of the following or from practice of the invention. The objectives and other advantages of the invention may be realized and attained by the structure particularly pointed out in the written description and claims hereof as well as the accompanying drawings.

In accordance with one embodiment of the invention, a digital filter roll-off factor control circuit for a transmitter comprises: an analog/digital converter for converting an analog signal to a digital signal; a data processing unit for compressing the digital signal provided by the analog/digital converter and correcting signal errors; a coder for coding the compressed signal provided by the data processing unit to an I phase output signal and a Q phase output signal; a digital filter, having a roll-off factor, for filtering the I phase and Q phase output signals; a modulator for modulating the filtered I phase and Q phase output signals and producing an intermediate frequency (IF) signal; a mixer for up-converting the IF signal provided by the modulator into a high frequency signal; a bandpass filter (BPF) for filtering the high frequency signal to remove noise; an amplifier for amplifying the filtered high frequency signal; and a filter control mechanism for controlling the digital filter by adjusting the roll-off factor.

In accordance with another embodiment, a method of controlling a digital filter of a transmitter comprises: detecting signals passed through a digital filter and an amplifier, the digital filter having a roll-off factor; measuring a power peak value based on the detected signals; calculating a peak-to-average power (PAP) ratio according to the power peak value; and adjusting the roll-off factor of the digital filter according to the PAP ratio.

It is to be understood that both the foregoing summary and the following detailed description of the invention include exemplary embodiments that are intended to provide further explanation of the invention. The content and the embodiments included in the summary and other parts of the application, however, are provided by way of example and should not be construed to limit the scope of the invention as claimed.

### BRIEF DESCRIPTION OF THE DRAWINGS

The accompanying drawings are included to provide a further understanding of the invention and are incorporated in and constitute a part of this specification. These drawings illustrate embodiments of the invention and together with the description serve to explain the principles of the invention.

FIG. 1 is a block diagram of a conventional transmitting part of a subscriber terminal for a WLL system;

FIG. 2A is a graph illustrating a filtering characteristic of a typical raised cosine filter;

FIG. 2B is a graph illustrating an impulse response of the typical raised cosine filter;

FIG. 3A is a QPSK signal vector diagram illustrating a constellation locus when a roll-off factor of a digital filter is 1.0;

FIG. 3B is a QPSK signal vector diagram illustrating a constellation locus when the roll-off factor of a digital filter is 0.75;

FIG. 3C is a QPSK signal vector diagram illustrating a constellation locus when the roll-off factor of the digital filter is 0.375;

FIG. 4 is a block diagram illustrating a digital filter control apparatus in accordance with one embodiment of the invention; and

FIG. 5 is a flow diagram illustrating a digital filter control method in accordance with one embodiment of the invention.

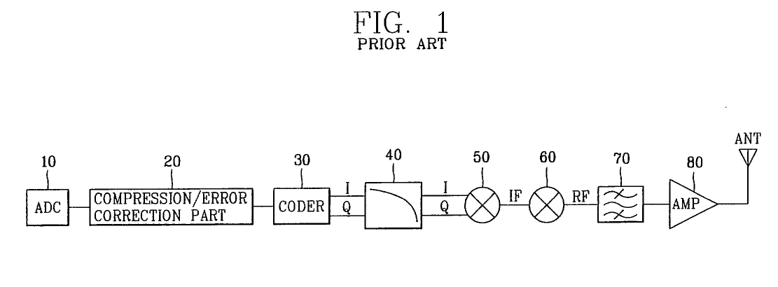

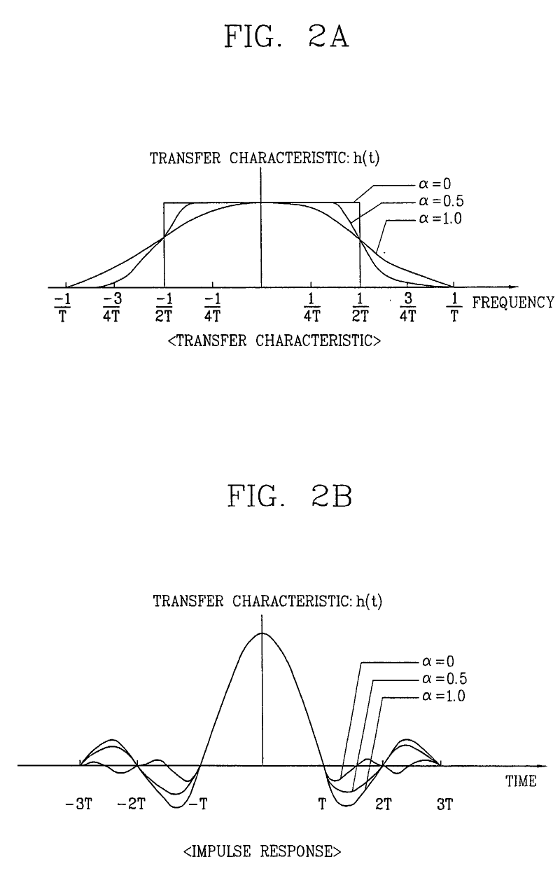

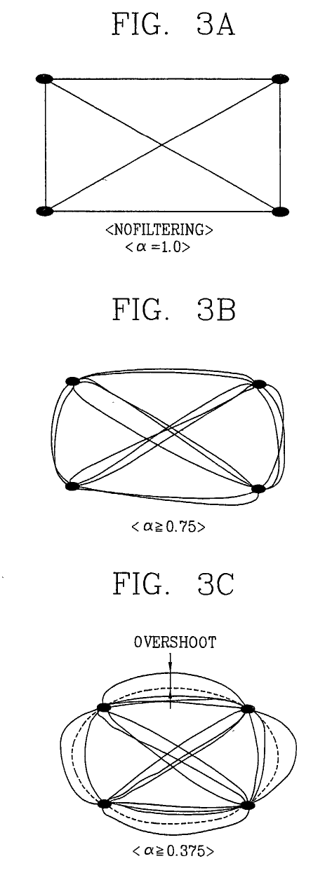

Features, elements, and aspects of the invention that are referenced by the same numerals in different figures represent the same, equivalent, or similar features, elements, or aspects in accordance with one or more embodiments.

Reference will now be made in detail to one or more embodiments of the invention, examples of which are illustrated in the accompanying drawings.

### DETAILED DESCRIPTION OF THE PREFERRED EMBODIMENTS

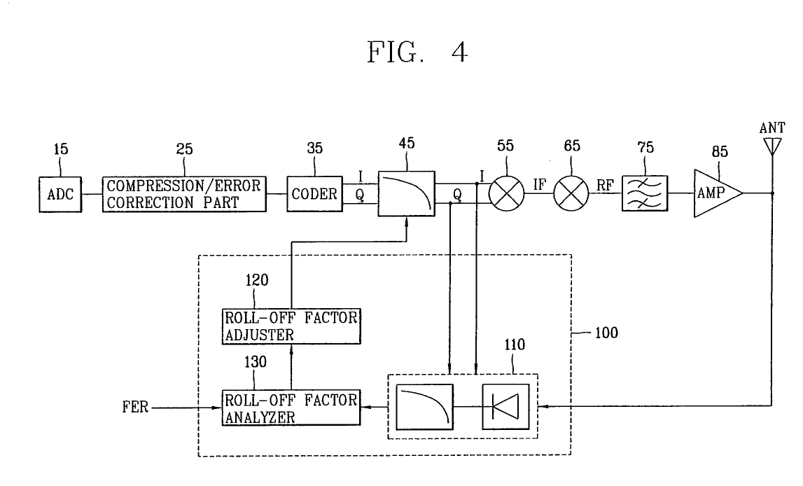

Referring to FIG. 4, in accordance with one embodiment of the invention, a digital filter control apparatus of the present invention comprises: an analog/digital converter (ADC) 15, a data processing unit 25, a coder 35, a variable digital filter 45, a modulator 55, a mixer 65, a bandpass filter 75, an amplifier 85, and a digital filter control unit 100. The ADC 15 converts an analog signal to a digital signal. The data processing unit 25 compresses signal provided by the ADC 15 and corrects signal errors.

The coder 35 codes the signal provided by the data processing unit 25 to an I phase output signal and a Q phase output signal. The variable digital filter 45 filters said I phase and Q phase output signals. The modulator 55 modulates the I phase and the Q phase signals filtered by the variable digital filter 45 to produce intermediate frequency (IF) signals. The mixer 65 converts signals received from the modulator 55 into high frequency signal. The bandpass filter 75 filters the high frequency signal to remove noise. The amplifier 85 amplifies the signal provided by the bandpass filter 75 and provides it to an antenna.

The digital filter control unit 100 measures system parameters such as the signals provided by the amplifier 85, the I phase and Q phase signals filtered by the digital filter 45, and a frame error rate (FER) provided by a receiving terminal. Based on the above parameters, the digital filter control unit 100 controls the digital filter 45 by way of a control signal.

In accordance with one embodiment, the digital filter control unit 100 comprises: a power detector 110 for measuring the I phase and Q phase output signals and the signal provided by the amplifier 85 to calculate a power peak value. The power detector 110 may comprise a Schottky diode and an LC filter, for example.

In some embodiments, the digital filter control unit 100 may further comprise a roll-off factor analyzer 130 for measuring the FER of the receiving terminal and the power level provided by the power detector 110. The roll-off factor analyzer 130 compares the power peak value calculated by the power detector 110 with an average transmission power to generate a control signal. In certain embodiments, the digital filter control unit 100 further comprises a roll-off factor adjuster 120 for controlling the variable digital filter 45 according to the control signal provided by the roll-off factor analyzer 130.

When the digital filter receives an analog signal for transmission, the ADC 15 converts the analog signal into a digital signal. The data processing unit 25 converts, compresses, and corrects any error in the digital signal. The coder 35 then separates the digital signal into the I phase and the Q phase output signals. The I phase signal and the Q phase signal are filtered in a preset roll-off factor range of the variable digital filter 45. The modulator 55 modulates the filtered I phase and Q phase signals into an IF signal and transmits the IF signal over a carrier frequency of a pertinent communication system. Bandpass filter 75 filters the carrier frequency to remove noise. Thereafter, the signal is amplified by the amplifier 85 and is then transmitted to a radio channel through the antenna.

In one or more embodiments, the power detector 110 of the digital filter control unit 100 detects the I phase and Q phase output signals provided by the variable digital filter 45 and the amplified signal provided by the amplifier 85 to measure a power peak value. The roll-off factor analyzer 130 analyzes the measured power peak value provided by the power detector 110. The roll-off factor analyzer 130 then determines whether or not the amplified signal is distorted depending on whether the power peak is in a linear region or in a saturation region and provides a roll-off factor control signal to the roll-off factor adjuster 120.

In accordance with one embodiment, the roll-off factor analyzer 130 measures a receiving terminal's FER and uses it for controlling the roll-off factor of the digital filter 45. If the power peak is amplified in the saturation region and/or the FER from the receiving terminal is greater than a threshold value (e.g., 1%), the roll-off factor analyzer 130 generates a control signal that increases the roll-off factor of the variable digital filter 45. The roll-off factor adjuster 120 controls the roll-off factor of the variable digital filter 45 according to the control signal provided by the roll-off factor analyzer 130.

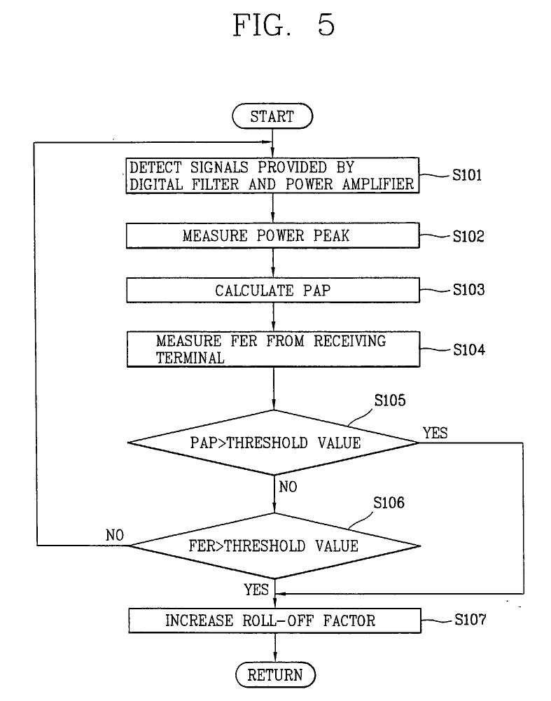

Referring to FIG. 5, when the transmitter transmits a signal, the digital filter control unit 100 detects I and Q phase signals provided by the variable digital filter 45 and the signal provided by the amplifier 85, at state S101. The digital filter control unit 100 then measures a power peak based on the detected signals, at state S102, to calculate a peak-to-average (PAP) ratio, at state S103. The digital filter control unit 100 then measures an FER from the receiving terminal, at state S104.

In one embodiment, the digital filter control unit 100 determines whether or not the PAP ratio is greater than a first threshold value, at state S105. If the PAP ratio is greater than the first threshold value, the digital filter control unit 100 increases the roll-off factor, at state S107. If, however, the PAP ratio is smaller than or equal to the first threshold value, the digital filter control unit 100 determines whether the FER of the receiving terminal is greater than a second threshold value, at state S106.

If the FER of the receiving terminal is less than or equal to the second threshold value, the system returns to state S101. Otherwise, if the FER of the receiving terminal is greater than the second threshold value, the digital filter control unit 100 increases the roll-off factor of the digital filter at state S107. Although, the various states discussed above have been illustrated in FIG. 5 to take place in a particular sequence, it should be noted that such sequential order is provided by way of example and may not be material to the proper operation of the system and apparatus of the invention. The provided states may take place in a different order in other embodiments of the invention to obtain substantially similar results.

In some embodiments, the digital filter control apparatus of the present invention adjusts the roll-off factor of the digital filter 45 based on the PAP of the amplifier 85 and the FER of the receiving terminal, such that the amplifier 85 operates in a linear region regardless of changes in the exterior conditions, resulting in enhancement of the communication reliability.

Additionally, since the roll-off factor adjustment of the filter 45 allows a low power amplifier to optimally operate for the transmitter, it is possible to reduce the size of the subscriber terminal and the manufacturing costs of the subscriber terminal due to the reduction in size and power of the amplifier 85. Reducing the size of the power amplifier 85, decreases the power consumption of the subscriber terminal, as well.

As such a method and apparatus for controlling the efficiency of a digital filter in a radio transmitter of a WLL system is provided. Although particular embodiments of the invention have been shown and described, it will be apparent to those skilled in the art that changes and modifications may be made without departing from the invention in its broader aspects, and therefore, the appended claims are to encompass within their scope all such changes and modifications that fall within the true scope of the invention.

What is claimed is:

1. A radio transmitter comprising:
an analog/digital converter for converting an analog signal to a digital signal;
a data processing unit for compressing the digital signal provided by the analog/digital converter and correcting signal errors;
a coder for coding the compressed signal provided by the data processing unit to an I phase output signal and a Q phase output signal;
a digital filter, having a roll-off factor, for filtering the I phase and Q phase output signals;
a modulator for modulating the filtered I phase and Q phase output signals and producing an intermediate frequency (IF) signal;
a mixer for up-converting the IF signal provided by the modulator into a high frequency signal;
a bandpass filter (BPF) for filtering the high frequency signal to remove noise;
an amplifier for amplifying the filtered high frequency signal; and
a filter control mechanism for controlling the digital filter by adjusting the roll-off factor.

2. The radio transmitter of claim 1, wherein the digital filter is a variable digital filter with an adjustable roll-off factor.

3. The transmitter of claim 1, wherein the filter control mechanism measures the amplified high frequency signal produced by the amplifier to obtain a first value.

4. The transmitter of claim 3, wherein the filter control mechanism further measures the I phase and Q phase output signals filtered by the digital filter to obtain a second value.

5. The transmitter of claim 4, wherein the filter control mechanism further measures a frame error rate (FER) of a receiving terminal to obtain a third value.

6. The transmitter of claim 5, wherein the digital filter control mechanism adjusts the roll-off factor based on at least one of the first, second, and third values.

7. The transmitter of claim 1, wherein the filter control mechanism comprises a power detector for measuring the I phase and Q phase output signals filter and the signal provided by the amplifier to calculate a power peak value.

8. The transmitter of claim 7, wherein the filter control mechanism further comprises a roll-off factor analyzer for calculating a peak-to-average power (PAP) ratio and generating a roll-off factor control signal.

9. The transmitter of claim 8, wherein the filter control mechanism further comprises a roll-off factor adjuster for adjusting the roll-off factor of the digital filter according to the roll-of factor control signal provided by the roll-off factor analyzer.

10. The transmitter of claim 9, wherein the roll-off factor analyzer measures a frame error rate (FER) provided by a receiving terminal and generates a roll-off factor control signal based on the FER.

11. The transmitter of claim 9, wherein the roll-off factor analyzer generates the roll-off factor control signal based on the PAP ratio and the FER.

12. The transmitter of claim 9, wherein the roll-off factor analyzer increases the roll-off factor if the PAP ratio is greater than a threshold PAP ratio.

13. The transmitter of claim 9, wherein the roll-off factor analyzer decreases the roll-off factor if the FER is greater than a threshold FER.

14. The transmitter of claim 1, wherein the transmitter is utilized in a WLL communication system.

15. A radio transmitter comprising:
an analog/digital converter for converting an analog signal to a digital signal;
a data processing unit for compressing the digital signal provided by the analog/digital converter and correcting signal errors;
a coder for coding the compressed signal provided the data processing unit to an I phase output signal and a Q phase output signal;
a variable digital filter, having an adjustable roll-off factor, for filtering the I phase and Q phase output signals;
a modulator for modulating the filtered I phase and Q phase output signals producing an intermediate frequency (IF) signal;
a mixer for up-converting the IF signal provided by the modulator into a high frequency signal;
a bandpass filter (BPF) for filtering the high frequency signal to remove noise;
an amplifier for amplifying the filtered high frequency signal; and
a filter control mechanism for controlling the roll-off factor of the digital filter, wherein, the filter control mechanism comprises:
a power detector for measuring the I phase and Q phase output signals provided by the digital filter and the signal provided by the amplifier to calculate a power peak;
a roll-off factor analyzer for calculating a peak-to-average power (PAP) ratio and generating a roll-off factor control signal; and
a roll-off factor adjuster for adjusting the roll-off factor of the digital filter according to the roll-of factor control signal provided by the roll-off factor analyzer.

16. The transmitter of claim 15, wherein the roll-off factor analyzer measures a frame error rate (FER) provided by a receiving terminal and generates a roll-off control signal in accordance to the FER.

17. The transmitter of claim 16, wherein the roll-off factor analyzer generates the roll-off factor control signal according to the PAP ratio and the FER.

18. The transmitter of claim 17, wherein the roll-off factor analyzer increases the roll-off factor if the PAP ratio is greater than a threshold PAP ratio.

19. The transmitter of claim 17, wherein the roll-off factor analyzer decreases the roll-off factor if the FER is greater than a threshold FER.

20. A method for controlling a digital filter in a transmitter, the method comprising:
detecting signals passed through a digital filter and an amplifier, the digital filter having a roll-off factor;
measuring a power peak value based on the detected signals;
calculating a peak-to-average power (PAP) ratio according to the power peak value; and
adjusting the roll-off factor of the digital filter according to the PAP ratio.

21. The method of claim 20 further comprising:
measuring a frame error rate (FER) provided by a receiving terminal; and
generating a roll-off control signal in accordance to the FER.

22. The method of claim 20, wherein adjusting the roll-off factor comprises:
determining whether the calculated PAP ratio is greater than a first threshold value; and
increasing the roll-off factor of the digital filter if the PAP ratio is greater than the first threshold value.

23. The method of claim 22, further comprises:
measuring a frame error rate (FER) of a receiving terminal; and
re-adjusting the roll-off factor of the digital filter according to the FER.

24. The method of claim 23, wherein re-adjusting the roll-off factor comprises:
determining whether the FER is greater than a second threshold value; and
decreasing the roll-off factor of the digital filter if the FER is greater than the second threshold value.

25. A method of controlling a digital filter in a transmitter comprising:
detecting signals passed through a digital filter and an amplifier of a transmitter;
measuring a power peak using the detected signals;
calculating a peak-to-average power (PAP) ratio based on the measured power peak;
measuring a frame error rate (FER) of a receiving terminal; and
adjusting the roll-off factor of the digital filter according to the measured PAP ratio and the FER.

26. The method of claim 25, wherein the step of adjusting the roll-off factor comprises:
determining whether or not the calculated PAP ratio is greater than a first threshold value;
increasing the roll-off factor of the digital filter, if the PAP ratio is greater than the first threshold value.

27. The method of claim 26, further wherein the step of adjusting the roll-off factor comprises:
determining whether or not the FER is greater than a second threshold value; and
decreasing the roll-off factor of the digital filter, if the FER is greater than the second threshold value.

28. The method of claim 27, wherein the transmitter is utilized in a WLL communication system.

29. A method of adjusting a digital filter in a transmitter of a WLL communication system, the method comprising:
converting an analog signal provided to a transmitter to a digital signal using a digital/analog converter;
compressing the digital signal and correcting the signal errors using a data processing unit;
coding the compressed signal to an I phase output signal and a Q phase output signal using a coder;
filtering the I phase and Q phase output signals using a variable digital filter, having an adjustable roll-off factor;
modulating the filtered I phase and Q phase output signals using a modulator to produce an intermediate frequency (IF) signal;
up-converting the IF signal into a high frequency signal using a mixer;
filtering the high frequency signal to remove noise using a bandpass filter (BPF);
amplifying the filtered high frequency signal; and
controlling the roll-off factor of the digital filter.

30. The method of claim 29, the controlling step comprising:
measuring the I phase and Q phase output signals and the amplified signal to calculate a power peak;
calculating a peak-to-average power (PAP) ratio and generating a roll-off factor control signal; and
adjusting the roll-off factor of the digital filter according to the roll-of factor control signal.
